(19) United States
(12) Patent Application Publication
(10) Pub. No.: US 2015/0144554 A1
(43) Pub. Date: May 28, 2015

(54) WASTEWATER TREATMENT PROCESS WITH MOVING BED BIOREACTOR (MBBR)

(71) Applicant: ANAERGIA INC., Burlington (CA)

(72) Inventors: Juan Carlos Josse, Mission Viejo, CA (US); Michael David Theodoulou, Milton (CA); Sasha Rollings-Scattergood, Fergus (CA)

(21) Appl. No.: 14/404,334

(22) PCT Filed: May 28, 2013
(86) PCT No.: PCT/CA2013/050408

§ 371 Date: Nov. 26, 2014

Related U.S. Application Data
(60) Provisional application No. 61/652,978, filed on May 30, 2012.
(60) Provisional application No. 61/676,124, filed on Jul. 26, 2012.
(60) Provisional application No. 61/676,131, filed on Jul. 26, 2012.

(51) Int. Cl. C02F 3/30; C02F 11/04; C02F 3/12; C02F 3/08; C02F 3/28

(52) U.S. Cl. CPC C02F 3/30; C02F 3/085; C02F 3/2833; C02F 3/286; C02F 3/2853; C02F 3/1273; C02F 11/04; C02F 2301/046
USPC 210/605; 210/195.1; 210/195.2; 210/607; 210/609; 210/620; 210/259; 210/195.3

(57) ABSTRACT

In a wastewater treatment system, feed water is processed by anaerobic digestion, preferably in an anaerobic moving bed bioreactor (AnMBBR). Effluent from the AnMBBR passes through one or more solid-liquid separation units. A solids portions is treated by hydrolysis or suspended growth anaerobic digestion. A liquid portion of the hydrolysis or suspended growth anaerobic digestion effluent is returned to the AnMBBR or blended with effluent from the AnMBBR. The AnMBBR effluent may be treated with an aerobic moving bed bioreactor (MBBR) before the one or more solid-liquid separation steps. Membrane filtration may provide a first solid-liquid separation step. A thickened waste stream may be withdrawn from a recirculation loop flowing from the first solid-liquid separation unit to the MBBR. Optionally, a solids portion separated from the feed water upstream of the AnMBBR may also be treated by hydrolysis or suspended growth anaerobic digestion.

### RELATED APPLICATIONS

This application claims priority from, and the benefit under 35 USC 119 of, U.S. Provisional Application No. 61/652,978 filed May 30, 2012, U.S. Provisional Application No. 61/676,124 filed Jul. 26, 2012 and U.S. Provisional Application No. 61/676,131 filed Jul. 26, 2012. U.S. Provisional Application No. 61/652,978, U.S. Provisional Application No. 61/676,124 and U.S. Provisional Application No. 61/676,131 are incorporated by reference.

### FIELD

This specification relates to systems and methods of wastewater treatment comprising anaerobic digestion.

### BACKGROUND

Despite increased regulation, many municipalities and industries still discharge wastewater with minimal or no treatment. Basic treatment would primarily removing chemical oxygen demand (COD), and might optionally remove one or more other contaminants. There is still a need for processes that provide basic treatment in a cost effective manner useful, for example, for treating wastewater with a total COD of 1000 mg/l or more and a significant amount of total suspended solids (TSS). It is preferable for the treatment process to have a low rate of net energy consumption.

### INTRODUCTION TO THE INVENTION

In a wastewater treatment system and process, feed water is processed in an anaerobic moving bed bioreactor (AnMBBR). Effluent from the AnMBBR passes through one or more solid-liquid separation steps. A solids portion of the AnMBBR effluent, optionally extracted after one or more process steps downstream of the AnMBBR, is treated by hydrolysis or anaerobic digestion (AD). A liquid portion of the hydrolysis or anaerobic digestion (AD) effluent is returned to the AnMBBR or a downstream biological nutrient removal step. Optionally, a solids portion separated from the feed water upstream of the AnMBBR may also be treated by hydrolysis or anaerobic digestion (AD).

In a wastewater treatment system and process, wastewater is treated with an aerobic moving bed bioreactor (MBBR) followed by a solid-liquid separation step such as membrane filtration. The MBBR and solid-liquid separation system operate with a recycle rate, if any, of less than 2 Q. A solids portion is extracted, preferably by a second solid-liquid separation unit, a digestion process, or both, in a liquid portion recycle loop. Optionally, the MBBR and solid-liquid separation unit may treat the effluent from an AnMBBR in the system and process described in the paragraph above.

In a wastewater treatment system and process, a primary wastewater stream is treated anaerobically, preferably in an anaerobic biofilm reactor, optionally with a downstream aerobic treatment step. Solids portions are removed from the primary wastewater stream before or after the anaerobic treatment, or both. The solids portions removed from the primary wastewater treatment stream are treated by hydrolysis or anaerobic digestion. A liquid portion of a hydrolyzed or anaerobic digestion effluent is returned to the primary wastewater stream.

Without intending to be limited by theory, the system and process are believed to be effective because the primary wastewater stream is intended to generally treat only soluble contaminants such as COD. This allows nearly single pass anaerobic, and any optional aerobic treatments, with low hydraulic retention times (HRT) (for example 24 hours or less or 6 hours or less) to be used. Particulate contaminates are separated, preferably concentrated, and hydrolyzed in a hydrolysis reactor or by anaerobic digestion. The hydrolysis reactor or anaerobic digestion operates efficiently by acidifying a concentrated solids feed in a small volume (compared to acidifying solids in the primary treatment anaerobic digester) and produces a soluble contaminant stream that may be returned to the primary wastewater stream to increase biogas production. In addition to efficiently removing COD, the process is able to operate with feed water having a TSS:COD ratio of over 0.12, which is about the limit for granular upflow anaerobic sludge blanket (UASB) and expanded granular sludge bed (EGSB) technology.

### BRIEF DESCRIPTION OF THE FIGURES

FIG. 1 is a process flow diagram for a wastewater treatment process.

FIG. 2 is a schematic plan view of a wastewater treatment system for implementing the process of FIG. 1.

FIG. 3 is a sectioned elevation view of the system of FIG. 2.

### DETAILED DESCRIPTION

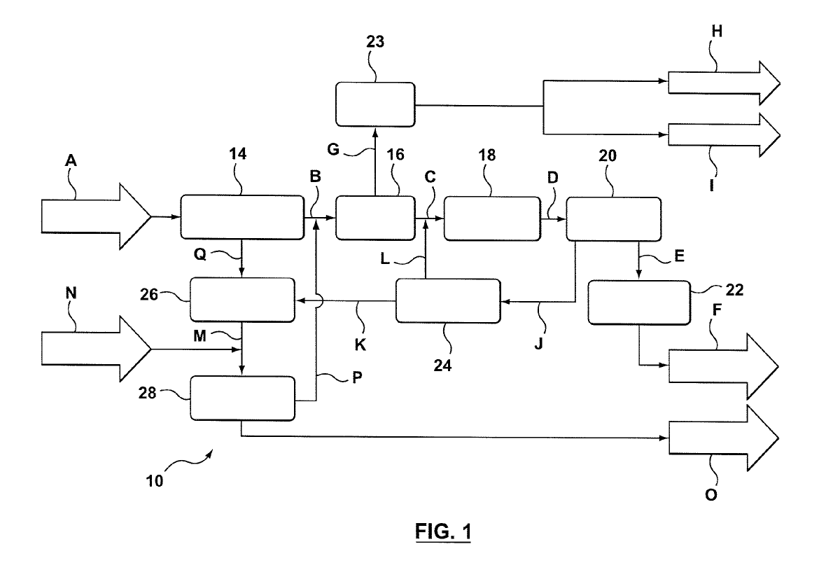

FIG. 1 shows a process 10 for treating wastewater. Optionally, at least some particulate COD and suspended solids may be removed near the start of the process. Influent, initially high in soluble COD, is treated anaerobically in a primary treatment stream and produces biogas. Optionally, the primary stream may also be treated aerobically. High solids streams, removed near the start of the process or in a downstream separation step, or both, are processed through hydrolysis or anaerobic digestion. A liquid fraction of the hydrolyzed or anaerobic digestion effluent is returned to the primary stream.

In the process 10, influent A flows through a primary treatment stream having steps of upstream solid-liquid separation 14, anaerobic digestion 16, preferably at an HRT of 24 hours or less or 6 hours or less, aerobic treatment 18, a first solid-liquid separation step 20 and, optionally, a disinfection step 22. Intermediate effluents or liquid portions B, C, D, E are produced between these steps. Final effluent F is produced after the disinfection step 22. Biogas G is produced by anaerobic digestion 16 and may be used as a fuel. The biogas G may be, for example, burned 23 to produce heat H or power I, or both.

A first solids portion stream J is treated in a second solid-liquid separation step 24. This step produces a second solids portion stream K and a liquid portion L. Liquid portion L is returned to the primary treatment stream. Second solids portion K, and an upstream solids portion Q, are treated by hydrolysis or anaerobic digestion 26 at an HRT of over 24 hours, typically 10 days or more. A hydrolysis or anaerobic digestion effluent M, optionally with the addition of a coagulant or flocculant N, is sent to a third solid-liquid separation step 28 (for example dewatering by a press). A third solids portion O is discharged, or processed further for re-use, for example as compost. A third liquid portion P is returned to the primary treatment stream.

In the description above, the terms solids portion and liquid portion indicate the higher solids content and lower solids content portions, respectively, of two streams produced from a solid-liquid separation device. The solids portion still contains some liquid, and the liquid portion may still contain some solids. Depending on the particular solid-liquid separation device used, the solids portion might be called screenings, cake, retentate, reject, thickened solids, sludge, bottoms or by other terms. The liquid portion might be called effluent, permeate, filtrate, centrate or by other terms.

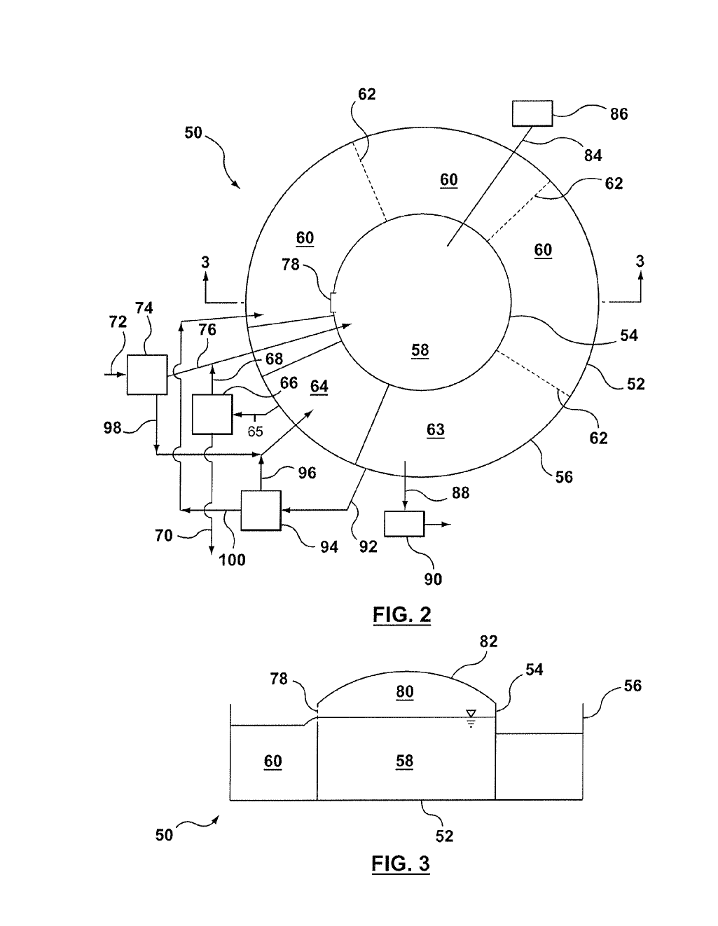

FIGS. 2 and 3 show a plant 50, which implements an example of the process 10. To deliver a compact design while providing enough tankage for the required unit processes, a ring-in-ring primary tank 52 is used. An inner tank 54 is used for an anaerobic digester 58 while the outer tank 56 is divided into spaces for an aerobic reactor 60, an immersed membrane tank 63 and a hydrolysis tank 64. In addition to the significant space savings, and some piping savings, the channel-like design of the outer tank 56 reduces short-circuiting in the aerobic reactor 60. As will be described below, the aerobic reactor 60 preferably contains a biofilm growth media. Intermediate screens 62 prevent the media from entering the membrane tank 63, divide the aerobic reactor into one or more of carbon removal, aerobic (nitrification), anoxic or anaerobic zones to remove carbon, nitrogen or other nutrients, and help distribute the media along the length of the aerobic reactor 60. The plant 50 typically treats a wastewater 72 with a total COD higher than 1,000 mg/L.

Inside the hydrolysis tank 64, particulate organic substrates and volatile suspended solids are converted into soluble substrates preferably by bacterial hydrolysis and optionally further digestion, for example by acidogenic bacteria. Even further digestion by methanogens is not necessary but, if present, may produce additional biogas that may be collected under a cover and added to biogas G. After hydrolysis or anaerobic digestion, the hydrolysis effluent 65 is sent to a press 66, such as a screw press sold by UTS Biogas GmbH. Press filtrate 68 containing a high concentration of soluble substrates is sent to the anaerobic digester 58. A cake 70 containing solids retained in the press 66 may be transported for disposal, land application or further treatment.

The wastewater 72 passes through a fine screen 74, for example with openings of about 500 um. Screened wastewater 76 is blended with the press filtrate 68 before being sent to the anaerobic digester 58.

Anaerobic digester 58 may be a high rate attached growth bioreactor such as a moving bed biofilm reactor (MBBR) preferably operating at a mesophilic temperature. Small plastic carrier elements are held in constant suspension via a submerged mixer while they are retained in the digester 58 through a mesh retention screen at the discharge. Raw biogas 84 produced in the anaerobic MBBR (AnMBBR) is first collected in a headspace 80 below a cover 82 over the inner tank 54. Raw biogas 84 may be treated for use in a combined heat and power (CHP) unit 86 or flared for ignition in emergency situations. The AnMBBR is capable of removing roughly 80% of the soluble COD. Additional COD, and optionally nitrogen or phosphorous or both, are removed in the aerobic reactor 60.

Optionally, effluent from the anaerobic digester 58 may be pumped to a heat exchanger where heat from the digester effluent is transferred to the digester influent 68, 76. Supplementary heat may be provided to the digester influent 68, 76 through a second heat exchanger fed hot water from the CHP unit 86. Following the heat exchanger loop, if any, the digester effluent outfalls into the aerobic reactor 60 through outlet 78. Alternatively, the outlet may be provided by way of an outlet pipe passing through the wall of a vertically oriented screening body such as a tube. Aerators outside of the screening body release bubbles from near the screening body to inhibit plugging of the screening body and recirculate media in the anaerobic digester. Effluent leaving the anaerobic digester flows first through the wall of the screening body, then into an entrance to outlet pipe. An outlet from the outlet pipe discharges into the next tank directly or through a heat exchanger. A suitable screening body is described in U.S. provisional application 61/676,131 filed on Jul. 26, 2012.

The aerobic reactor 60 may be an aerobic moving bed bioreactor (MBBR) or another attached growth bioreactor. In this MBBR compartment, additional soluble COD is oxidized by heterotrophs which accumulate as biofilm on carrier elements. Heterotrophs have very high growth rates and high biomass yields which often displace slower growing nutrient removing bacteria in highly loaded reactors. Therefore, a second or third compartment may be provided to preferentially select for autotrophic organisms that nitrify ammonia downstream of a carbon oxidation basin. As with the carbon oxidizing basin, the nitrification basin contains MBBR carrier elements for biomass attachment. Intermediate screens 62 are installed between compartments to differentiate the organic carbon oxidation and nitrification zones from each other and any additional nitrification, anoxic and anaerobic zones. Alternatively, other forms of aerobic reactor may be used, such as a suspended growth or IFAS reactor. If additional nitrogen removal is required, stages may be provided to include, for example, nitrification and denitrification (for example by modified Ludzack-Eltinger (MLE) process), nitritation and denitritation, SHARON reactor, or treatment with annamox bacteria.

When combined, the anaerobic heterotrophic organisms in the AnMBBR and the aerobic heterotrophs and autotrophs in the aerobic MBBR produce large quantities of suspended solids as a result of substrate utilization and biomass yield. This biomass, and remaining solids from the wastewater 72, are removed in the membrane tank 63. The membrane tank 63 includes immersed microfiltration or ultrafiltration membranes, for example in a flat sheet or hollow fiber configuration. Alternatively, an external pressure driven membrane system may be used. The hybrid aerobic MBBR and membrane system is referred to in this specification as a moving bed membrane bioreactor (MBMBR) and is capable of producing a permeate 88 well suited for reuse applications. The MBMBR operates with a once through flow, or with a limited recirculation up to about twice the influent flow rate (2 Q). Any recirculation is preferably of a liquid fraction of the membrane reject 92. The returned liquid fraction preferably has a flow rate of 1 Q or less. Reactor 60 has a low suspended solids concentration relative to a conventional suspended growth membrane bioreactor. The membrane reject stream 92 therefore has a low suspended solids concentration (relative to a conventional suspended grown membrane bioreactor), in some cases less than 8,000 mg/L, for example 2,000 to 6,000 mg/L.

A membrane system is particularly useful when a hygienic, low turbidity effluent is required, but other solid-liquid separation unit process may also be used. For example, sedimentation is an acceptable solid-liquid separation unit process for removing considerable suspended solids. Chemically enhanced sedimentation may be used with high organic loading rates. Dissolved air flotation (DAF), micro-screening or chemically enhanced microscreening may also be used.

Within the membrane tank 63, a series of submerged membrane modules are connected to form one or more larger cassettes of membranes. A slight vacuum is applied to the interior of the membrane modules and permeate 88 is drawn from the membrane tank 63 through the membrane surface. Permeate 88 is directed to a storage tank 90 and may be re-used, for example as process water within a facility producing the wastewater 72 and for membrane cleaning requirements. Optionally, for reuse applications requiring Title 22 conformity, the permeate 88 may be sent to a UV disinfection unit 90 before it is reused.

As clean permeate 88 is drawn across the membrane surface, solids concentrate within the membrane tank 62. Reject 92 is drawn out of membrane tank 62 as a constant bleed and sent first to a thickener 94. Thickened sludge 96 with retained screenings 98 from fine screen 74 flows into the hydrolysis tank 64. The total suspended solids concentration in the membrane reject 92 is typically around 0.5% or more, generally between 0.2% and 0.8%. Via the thickener 94, such as a rotary drum thickener (RDT), belt press, centrifuge or other sludge dewatering device, the membrane rejects 92 are thickened to roughly 6% to reduce the required volume of the hydrolysis tank 64. The filtrate 100 from thickener 94 contains a relatively low COD and nutrient content and is therefore diverted to the aerobic reactor 60 for eventual withdrawal as permeate 88.

In a design example, an AnMBBR and MBMBR process is proposed for treating effluent from an agricultural produce processing facility. The facility produces wastewater with an average daily flow of 1.4 MGD (million gallons per day). The wastewater is industrial in nature and contains no sanitary wastewater, although the process can also be applied to sanitary wastewater.

Parameters describing the wastewater after a preliminary coarse screening are described in Table 1. Based on ratios as a function of COD, nitrogen, phosphorus, sulphur and magnesium were not inhibitory for anaerobic digestion. Alkalinity should be provided at a rate of approximately 500 mg/L to prevent souring of the anaerobic digester 58.

TABLE 1
Wastewater parameters

| Parameter | Concentration | Units |
|---|---|---|
| Total Solids | 2,100 | mg/l |
| Total Volatile Solids | 1,600 | mg/l |
| Total Dissolved Solids | 690 | mg/l |
| Total Suspended Solids | 730 | mg/l |
| Volatile Suspended Solids | 670 | mg/l |
| COD, Total | 1,700 | mg/l |
| COD, Particulate | 880 | mg/l |
| COD, Soluble | 820 | mg/l |
| Ammonia as N | 0.92 | mg/l |
| TKN | 29 | mg/l |
| NO2 + NO3 as N | 290 | ug/l |
| Sulfur, Total | 29 | mg/l |
| Magnesium, Total | 21 | mg/l |
| Calcium, Total | 100 | mg/l |
| Phosphate as PO4, Total | 17 | mg/l |

To produce a well oxidized effluent, the soluble COD is first removed via anaerobic digestion and finally polished via aerobic oxidation.

The design of the AnMBBR is largely based on organic loading rates (OLR). OLRs for AnMBBRs treating a variety of industrial wastewaters are presented in Table 2. Further development of the OLR through application of the filling fraction, bulk specific surface area of the media, and the resulting net specific surface area of the media yields the surface area loading rate (SALR) for the MBBR. These results are presented in Table 3.

TABLE 2
Range of organic loading rates applied to AnMBBR processes for a
variety of wastewater sources

| Organic Loading Rate | % COD Removal | Wastewater | Reference |
|---|---|---|---|
| 2.0 kg COD/m³ · d | 86.3% | Dairy - high | Wang et al (2009) |
| 20.0 kg COD/m³ · d | 73.2% | strength milk | |
| | | permeate from | |
| | | ultrafiltration based | |
| | | cheese process | |
| | | water | |
| 4.08 kg COD/m³ · d | 91% | Landfill leachate | Chen et al (2008) |
| 15.7 kg COD/m³ · d | 86% | | |
| 1.6 kg sCOD/m³ · d | 89.2% | Vinasses - Wine | Sheli & Moletta (2007) |
| 29.6 kg sCOD/m³ · d | 81.3% | distillery | |
| | | wastewater | |

TABLE 3
Surface area loading rate corresponding to the organic loading rate for
AnMBBR treating industrial wastewaters

| | | | Bulk | |
|---|---|---|---|---|
| | | | Specific | Net Specific |
| | Surface Area Loading | Filling | Surface | Surface |
| OLR Range | Rate | Fraction | Area (m²/m³) | Area (m²/m³) |
| 2.0 kg COD/m³ · d | 5.8 g COD/m² · d | 65% | 530 | 345 |
| 20.0 kg COD/m³ · d | 58 g COD/m² · d | | | |
| 4.08 kg COD/m³ · d | 11.3 g COD/m² · d | 40% | 900 | 360 |
| 15.7 kg COD/m³ · d | 43.6 g COD/m² · d | | | |
| 1.6 kg sCOD/m³ · d | 4.6 g sCOD/m² · d | 66% | 528 | 348 |
| 29.6 kg sCOD/m³ · d | 84.9 g sCOD/m² · d | | | |

As shown in the above tables, a large range of OLRs and SALRs are possible while still yielding adequate COD removal. Although good COD removals are achieved, process stability is often hindered by very high loading rate. Acidification of the reactor, build-up of volatile fatty acids (VFA) and washout of the biomass have been reported for high rate reactors. For this reason, a moderate loading rate is preferred. For the current design a 6 kg sCOD/m³·d OLR and 20 g sCOD/m²·d SALR have been selected.

For the loading rate selected, the volume of the digester was determined based on the expected soluble COD loading. The HRT for the reactor is than calculated with the resulting digester volume and design flow rate through the digester.

For all MBBR processes, the filling fraction is limited to a maximum of 70% (volume of carriers per volume of reactor). This upper limit is to allow carrier elements to move freely in suspension without balling or creating short circuiting through the reactor. Most commonly, the filling fraction is selected close to this maximum value to reduce tankage requirements. In this design a filling fraction of 60% is specified which when combined with a media specific surface area of 500 m²/m³ yields 300 m²/m³.

Due to the short hydraulic retention time, the anaerobic digester is limited to removal of soluble COD only. The best way to determine the soluble COD removal is through treatability testing or pilot testing. However, for the purpose of preliminary design an empirical formula (Equation 1) is used.

E=(1−Sₖ·HRT^{-m}) Equation 1

### Where

E=COD removal, %
Sₖ=System coefficient
m=Process coefficient

For the anaerobic attached growth process, Sk and m are 1 and 0.85-1.0 respectively with selected values of 1 and 0.95 respectively. The removal rate was verified with previous studies shown in Table 2.

Biomass yield was estimated using the relationship between COD reduced and biomass generated. Typical values from the literature are 0.054 g VSS/g COD_{Removed} for landfill leachate, 0.057 g VSS/g COD_{Removed} for food waste, 0.054 g VSS/g COD_{Removed} for VFA mixture and 0.079 g VSS/g COD_{Removed} for milk whey. A value of 0.057 g VSS/g COD_{Removed} is selected here.

For determining the methane production, a mass balance of the soluble COD sent to the digester was performed (Equation 2). The relationship for influent COD and effluent COD was previously discussed, whereas the biomass yield was converted to COD via the typical 1.42 g COD/g VSS relationship. COD available for methane was converted to volume of methane according to 0.40 m³ CH₄/kg COD_{METHANE} and then to biogas by assuming methane comprised 65% of biogas.

sCOD_{METHANE}=sCOD_{IN}−sCOD_{eff}−sCOD_{VSS} Equation 2

### Where

sCOD_{METHANE}=Portion of influent COD converted to methane, kg/d
   sCOD_{IN}=Influent COD, kg/d
   sCOD_{eff}=Effluent COD, kg/d
   sCOD_{VSS}=Portion of influent COD converted to biomass, kg/d

Biogas produced in the AnMBBR should be sent to CHP production. For estimating potential electrical energy production, and efficiency for CHP of 41% is assumed. Additionally, it is estimated that 43% of the total energy is converted to usable thermal energy during the production of electrical energy.

Similar to the design of the AnMBBR, the surface area loading rate is an important design parameter for design of the aerobic system. Typically, the SALR is given in units of g/m²·d which relates the organic load on the specific surface area of media. A high rate SALR is 24 g COD/m²·d or 12.1 g sCOD/m²·d whereas a low rate SALR is 7 g COD/m²·d or 3.4 g sCOD/m²·d (Leiknes & Odegaard, 2006).

The major differentiation between the low-rate and high-rate reactors is that nitrification occurs in low-rate reactors. Although selection of a SALR that would be classified as low-rate would provide simultaneous nitrification and organic carbon removal, it is often hindered by the highly favorable organic carbon oxidizing process. For this reason, a two compartment system is superior in design and selected. The design SALR for the first aerobic compartment was set at 7.5 g sCOD/m²·d at 20° C. (≈15.5·gCOD/m²·d).

In this example, the MBBR operates in high ambient air temperatures and treats effluent from a mesophilic anaerobic MBBR cooled through heat exchangers. As a result, the expected basin temperature is 22° C. SALR and other reaction rate coefficients typical to the aerobic MBBR system can be corrected according to the van't Hoff-Arrhenius relationship using Equation 3:

k_{T}_{_{Design}}=k_{20° C.}·θ^{T}^{_{Design}}^{-20° C.} Equation 3

### Where

k_{T}_{_{Design}}=reaction rate, or constant, at design temperature T_{Design}
k_{20° C.}=reaction rate, or constant, observed at 20° C.
   θ=temperature coefficient (≈1.1 in the absence of a system specific value)

The basin volume is calculated according to the temperature corrected surface area loading rate, the net specific surface area and the influent substrate loading according to Equation 4:

$$V = \frac{S \cdot 1 , 000 g \text{/} kg}{SALR \cdot NSSA} \qquad Equation 4$$

### Where

V=Volume of reactor, m³
S=Substrate load, kg/d
SALR=Surface area loading rate on media, g/m²/d
NSSA=Net specific surface area of the media, m²/m³

Aerobic heterotrophic organisms have significantly higher biomass yields as compared to the anaerobic heterotrophs and aerobic autotrophs in the other reactor compartments. The heterotrophic sludge yield was set to 0.40 g VSS/g CODRed for estimating biomass growth. As with the assumption for the anaerobic reactor, it was assumed that only soluble COD was oxidized and the particulate matter and VSS was not hydrolyzed in the short HRT single pass set-up of the MBBR. This is an appropriate assumption as biofilm reactors are efficient at removing soluble organic matter but have limited ability to treat particulate matter (Leiknes & Odegaard, 2006).

As with the design for the AnMBBR, a filling fraction of 60% is specified for the carbon oxidation basin and the nitrification basin. When combined with a media providing 500 m²/m³ bulk specific surface area, a net specific surface area of 300 m²/m³ is produced in the reactor.

The rate of nitrification is highly dependent on the BOD loading rate. Nitrification rates in MBBRs receiving 1) a total BOD₅ load of 1 to 2 g/m²·d are in the range of 0.7 to 1.2 g/m²·d; 2) a total BOD₅ load of 2 to 3 g/m²·d are in the range of 0.3 to 0.8 g/m²·d; and 3) a total BOD₅ load greater than 3 g/m²·d resulted in virtually no nitrification (McQuarrie & Boltz, 2011). A two compartment system is proposed to minimize the BOD load on the second compartment. Assuming that 90% of BOD is removed in the first compartment, the total BOD load will be below 1 g/m²·d in the nitrification compartment.

Additionally, the dissolved oxygen concentration is known to be rate limiting for systems with effluent design NH₄—N concentrations above 3 g/m³. The selected design SALR for nitrification is 1.37 g NH₄—N/m²·d at 20° C. Correction to design temperature was performed using Equation 3. The basin volume was calculated by applying Equation 4, with NH₄—N as the substrate and the temperature corrected SALR above mentioned. As with the organic carbon reactor, a fill fraction of 60% is selected.

As with the carbon oxidizing basin, biomass production is considered via solids yield. The sludge yield for nitrifying bacteria was taken from typical design for biofilm processes and found to be 0.05 g VSS/g N_{Red}.

In addition to nitrification, ammonia nitrogen is assimilated into cell mass at a weight percent of approximately 12.2%. Two important assumptions are made in terms of nitrogen balance: 1) all organic nitrogen in the influent is hydrolyzed into ammonia nitrogen; and 2) only biomass discarded in the dewatered cake represents a sink for assimilated nitrogen in cell mass. The second assumption is critical since the membrane rejects, which are largely comprised of biomass, are thickened and returned for hydrolysis which liberates the nitrogen.

Aeration is provided to the carbon oxidizing and nitrification reactors. Aeration calculations are based on the standard aeration equation shown in Equation 5. Nitrification requires considerable oxygen input and aeration requirements are based on 4.57 kg O2/kg NH₄—N removed.

$$AOTR = SOTR ( \frac{β {C}_{\overline{s} , T , H} - {C}_{L}}{{C}_{s , 20}} ) {1.024}^{T - 20} α F \\ Where \\ AOTR = Actual oxygen transfer rate under field conditons , kg {O}_{2} \text{/} hr \\ SOTR = Standard oxygen transfer rate in tap water at 20 ° C . , kg {O}_{2} \text{/} hr \\ β = Salinity - surface tension correction factor , 0.95 \\ {C}_{s , T , H} = Aeration basin DO sat . conc . in clean water at temperature T and altitude H , mg / {LC}_{s , T , H} = Oxygen sat . conc . in clean water at temperature T and altitude H , mg \text{/} L \\ T = Temperature of basin , ° C . \\ α = Oxygen transfer correction factor for waste , 0.65 \\ F = Fouling factor , 0.9 \qquad Equation 5$$

In this example, flat sheet ultrafiltration membrane modules are used for solid liquid separation after complete carbon oxidation and nitrification. The modules are submerged within a distinct tank, separated by carrier retention screens. As this is a MBBR process, no return activated sludge line is provided and instead a membrane reject line removes solids accumulated in the membrane tank. The membrane system is operated under permeate/relaxation regime with a design cycle of 9.5 minute permeate period followed by a 30 second relaxation period. The design recovery rate is 90% to achieve approximately 6 g TSS/L (6 g MLSS/L) inside the membrane tank. The design permeate flux is 25.5 L/m²/hr (LMH) or 15 GFD (gal/ft²/d). To increase membrane performance, the membrane modules will be scoured through vigorous recirculation pumping during relaxation periods. The flowrate for the recirculation pumping is set at 5 times the permeate flow.

Maintenance cleaning can be performed in-situ through backpulse of the membranes with permeate from the permeate storage tanks and aided through the addition of chemicals through dosing pumps. Current design allows for a maintenance cleaning protocol consisting of citric acid and sodium hypochlorite solutions.

Large solids are removed from the raw facility influent with 1-2 mm screen. However, there is still considerable TSS and particulate COD in the influent that can be removed to benefit the MBBR operation. An inline rotary drum fine screen has been selected to further reduce particulate matter with estimates solids removal of 40% of the influent particulate. It is assumed that the screenings will form a 6% TS cake that will be sent to hydrolysis.

By flocculating the membrane bleed line with a low dose of polymer, successful thickening up to approximately 6% is achievable via a RDT. Solids capture rate is superior in RDTs with a selected design value of 98%. With such high capture rates, the filtrate from thickening is relatively low in COD and ammonia. To avoid dilution of the digester feed, the filtrate from the RDT is directed to the influent of aerobic tank. Thickened solids are sent to the hydrolysis tank for co-processing with the particulate organic matter removed via fine screen from the influent.

The hydrolysis unit is provided to lyse the particulate COD present in the VSS from membrane compartment rejects and screenings from the preliminary fine screen. The thermophilic hydrolysis process will reduce the amount of solids requiring land application while increasing the amount of biogas production. Design for the hydrolysis unit considered HRT of the reactor, maximum degradability of substrate and the first order hydrolysis rate coefficient.

Maximum degradability for the screenings and waste sludge as well as the hydrolysis rate coefficients were found in literature and reported in Table 4. A HRT of 2 days was selected as the maximum degradability was reached for waste sludge and almost reached for screenings.

To separate the non-biodegradable solids from the soluble COD, the hydrolysis effluent is sent to dewatering. The filtrate from dewatering is sent for digestion with the screened influent and the solids are removed for land application.

TABLE 4
Hydrolysis tank reaction rate coefficients and maximum degradability
estimates

| | Hydrolysis | Maximum | |
|---|---|---|---|
| Waste Type | Coefficient (d⁻¹) | Degradability | Reference |
| Waste sludge from | 0.65* | 45% | Ge et al. (2011) |
| membrane rejects | | | |
| Screenings from the | 0.35*^{e} | 60%^{e} | Ge et al. (2011) |
| microscreen | | | |

*For hydrolysis tank temperature of 60° C.
^{e}Values based on primary sludge

Dewatering of the hydrolysis effluent is achieved using a sludge screw dewaterer, also known as a screw press. However, any sludge dewatering device such as a centrifuge, belt press, rotary press or volute dehydrator could be used. Design of the dewatering system is based on an assumed cake concentration of 25%, a solids capture rate of 95% and a polymer dose of 8 kg/ton of TS (16 lbs/ton of TS). Because ultrafiltration membrane separation is applied at the outfall of the facility, the dewatered cake is assumed to be the only waste point for solids.

In a second design example, an AnMBBR and MBMBR process is proposed for treating about 1 MGD of wastewater having of COD concentration of about 6500 mg/l and about 2000 mg/l of suspended solids. In this example, referring to FIG. 1, hydrolysis or anaerobic digestion 26 is provided by a conventional suspended growth anaerobic digester rather than a hydrolysis unit as in the first design example. The second solid-liquid separation step 24 is optional. Filtrate P from dewatering sludge from the suspended growth anaerobic digester passes through an ammonia stripper and is blended with effluent from the anaerobic digestion step 16, which is by way of an AnMBBR. Aerobic treatment 18 and first solid liquid separation 20 are by MBMBR. Optionally, the suspended growth anaerobic digester 26 may treat other waste in addition to solids from influent A and rejects J from the first solid-liquid separation step 20. Solids are separated from influent A in an upstream solid-liquid separation step 14 provided by a dissolved air flotation (DAF) unit which produces an influent B having about 5000 mg/l of COD and about 250 mg/l of suspended solids.

The high COD nature of the wastewater is well suited for anaerobic biofilm treatment and if otherwise treated aerobically would require high energy demands for aeration and produce large quantities of sludge. In this design, the post-DAF wastewater flows into the AnMBBR where 80% of the COD is removed and converted partially to biomass and the majority to biogas. A high organic loading rate of 14 kg sCOD/m³·d is selected. To accommodate the loading rate, the AnMBBR is packed with 70% media with a 500 m²/m³ specific surface area which yields a SALR of 39 g sCOD/m²·d.

Biogas produced in the AnMBBR is sent to a CHP which may also receive biogas from the suspended growth anaerobic digestion. After anaerobic treatment the effluent is treated with centrate from the suspended growth anaerobic digestion in the MBMBR. Combined, these streams have a high concentration of nitrogen. Nitrification to remove ammonia occurs simultaneously along with carbon oxidation at the beginning of the MBMBR process. Oxidized nitrogen, which requires denitrification, is treated at the end of the MBMBR process using post-denitrification through the addition of external carbon in the form of glucose. Aerobic SALR is set to 12 g sCOD/m²·d while denitrification SALR is set to 2.5 g NO₃—N/m²·d. To handle the SALR while limiting tankage, a filling fraction of 70% is used with a media containing a 500 m³/m³ specific surface area.

Solid-liquid separation is achieved via membrane filtration with flat sheet modules. Membrane recovery rate for this design is 88% which produces a reject stream 0.8% in solids. A conservative flux is proposed and is 17 L/m²/hr (LMH). The liquid stream is a clean effluent and proceeds to disinfection whereas the concentrated reject stream from the membrane tank is sent to the conventional (suspended growth) anaerobic digester for further treatment.

The two design examples described above are meant to help describe optional details of the methods and systems described more generally further above but not to limit them. While the design examples may provide some useful guidance, any one or more of the specific parameters given may be changed, for example within a range of 50% to 150% of the values given. Other variations may also be made within the scope of the invention, which is defined by the claims.

The references mentioned above are as follows:
Chen, S.; Sun, D.; Chung, J-S (2008) Simultaneous removal of COD and ammonium from landfill leachate using an anaerobic-aerobic moving-bed biofilm reactor system. Waste Management, 28, 339-346.
Ge H.; Jensen, P. D.; Batstone, D. J. (2011) Temperature phased anaerobic digestion increases apparent hydrolysis rate for waste activated sludge. Water Research. 45, 1597-1606.
Leiknes, T.; Odegaard, H. (2006) The development of a biofilm membrane bioreactor. Desalination. 202, 135-143.
McQuarrie, J. P.; Boltz, J. P. (2011) Moving bed biofilm reactor technology: Process applications, design, and performance. Water Environment Research, 83 (6), 560-575.
Sheli, C.; Moletta, R. (2007) Anaerobic treatment of vinasses by a sequentially mixed moving bed biofilm reactor. Water Science & Technology, 56 (2), 1-7.
Wang, S.; Rao, N. C.; Qiu, R.; Moletta, R. (2009) Performance and kinetic evaluation of anaerobic moving bed biofilm reactor for treating milk permeate from dairy industry.

1. A wastewater treatment system comprising,
a) an anaerobic biofilm bioreactor;
b) one or more solid-liquid separation units adapted to receive effluent from the anaerobic moving bed bioreactor;
c) a hydrolysis unit or suspended growth anaerobic digester adapted to receive a solids portion from the one or more solid-liquid separation units; and,
d) a dewatering unit adapted to receive an effluent from the hydrolysis unit or suspended growth anaerobic digester and deliver a liquid portion of the effluent to the anaerobic biofilm bioreactor.

2. The wastewater treatment system of claim 1 further comprising,
e) a solid-liquid separation unit in communication with the wastewater upstream of the anaerobic biofilm bioreactor adapted to remove a solids portion from the wastewater, wherein the hydrolysis unit or suspended growth anaerobic digestion is adapted to receive the solids portion of the wastewater and return an effluent to the wastewater.

3. The wastewater treatment system of claim 1 further comprising,
f) an aerobic moving bed bioreactor adapted to treat effluent from the anaerobic moving bed bioreactor upstream of the one or more solid-liquid separation units.

4. The wastewater treatment system of claim 1 wherein the one or more solid-liquid separation units further comprise,
g) a first solid-liquid separation unit; and,
h) a second solid-liquid separation unit adapted to receive a solids portion from the first solid-liquid separation unit.

5. The wastewater treatment system of claim 4 wherein the first solid-liquid separation unit comprises a membrane filter.

6. The wastewater treatment system of claim 4 wherein a liquid portion is returned from the second solids separation unit to the effluent from the anaerobic biofilm bioreactor.

7. The wastewater treatment system of claim 6 comprising an aerobic moving bed bioreactor wherein the liquid portion is returned from the second solids separation unit to the effluent from the anaerobic biofilm bioreactor upstream of the aerobic moving bed bioreactor.

8. A process for treating wastewater comprising a step of treating wastewater in a system of claim 1.

9. A wastewater treatment system comprising,
a) an aerobic moving bed bioreactor;
b) a first solid-liquid separation unit adapted to receive an effluent from the aerobic moving bed bioreactor.

10. The wastewater treatment system of claim 9 wherein the first solid-liquid separation unit comprises a membrane filtration unit.

11. The wastewater treatment system of claim 9 having a recirculation loop between a solids portion outlet of the first solid-liquid separation unit and the aerobic moving bed bioreactor.

12. The wastewater treatment system of claim 11 having a second solid-liquid separation unit in the recycle loop.

13. The wastewater treatment system of claim 9 having a hydrolysis unit or suspended growth anaerobic digester adapted to receive at least some of the solids portion from the first solid-liquid separation unit and to return a hydrolyzed effluent to the aerobic moving bed bioreactor.

14. The wastewater treatment system of claim 13 having a solid-liquid separation unit adapted to extract a solids portion from the hydrolyzed effluent before the hydrolyzed effluent is returned to the aerobic moving bed bioreactor.

15. The wastewater treatment system of claim 9 having an anaerobic biofilm digester upstream of the aerobic moving bed bioreactor.

16. The wastewater treatment system of claim 15 wherein the anaerobic biofilm digester receives returning hydrolyzed effluent.

17. The wastewater treatment system of claim 15 wherein the anaerobic biofilm digester is a moving bed bioreactor.

18. The wastewater treatment system of claim 9 comprising an upstream solid-liquid separation unit adapted to remove a thickened effluent from the wastewater wherein separated solids are hydrolysed and returned, at least in part, to the wastewater.

19. The wastewater treatment system of claim 18 wherein the thickened effluent is hydrolysed in a hydrolysis unit or suspended growth anaerobic digester that also treats the thickened stream from the second solids separation unit.

20. A wastewater treatment process comprising treating wastewater in a wastewater treatment system according to claim 9.

21. A process for treating wastewater comprising the steps of,
a) treating a primary wastewater stream anaerobically at an HRT of 24 hours or less;
b) removing solids from the primary wastewater before or after step a), or both;
c) treating solids removed in step b) by hydrolysis or suspended growth anaerobic digestion to produce an hydrolyzed effluent; and,
d) returning a liquid portion of a hydrolyzed effluent to the primary wastewater stream.

22. The process of claim 21 further comprising treating the primary wastewater stream aerobically.

23. The process of claim 21 further wherein a solids portion is removed after step a) and thickened before being treated by hydrolysis or suspended growth anaerobic digestion.
